(19) United States
(12) Patent Application Publication
(10) Pub. No.: US 2011/0253491 A1
(43) Pub. Date: Oct. 20, 2011

(54) Disk Brake Assembly

(76) Inventors: Guido Zenzen, Macken (DE); Marco Becker, Oberdurenbach (DE)

(21) Appl. No.: 13/129,873

(22) PCT Filed: Nov. 16, 2009
(86) PCT No.: PCT/EP09/08149

§ 371 Date: Jun. 16, 2011

(30) Foreign Application Priority Data
Nov. 25, 2008 (DE) 10 2008 058 975.6

(51) Int. Cl. F16D 65/095; B23P 11/02; F16B 4/00

(52) U.S. Cl. 188/206 A; 29/446

(57) ABSTRACT

The invention relates to a disk brake assembly comprising a brake anchor plate for fastening to a vehicle as well as a brake pad assembly, wherein the brake anchor plate has at least one location opening for receiving a guide element that has a first portion for guiding and supporting the brake pad assembly and a second portion for connecting to the brake anchor plate. For simplified manufacture while retaining a permanently reliable mode of operation, it is provided that the second portion has a textured surface, by which the guide element may be press-fitted at least partially into the location opening.

### CROSS-REFERENCE TO RELATED APPLICATIONS

This application is a national stage of International Application No. PCT/EP2009/008149 filed Nov. 16, 2009, the disclosures of which are incorporated herein by reference in entirety, and which claimed priority to German Patent Application No. 10 2008 058 975.6 filed Nov. 25, 2008, the disclosures of which are incorporated herein by reference in entirety.

### BACKGROUND OF THE INVENTION

The invention relates to a disk brake assembly comprising a brake anchor plate for fastening to a vehicle as well as a brake pad assembly. The brake anchor plate has at least one location opening for receiving a guide element that has a first portion for guiding and supporting the brake pad assembly and a second portion for connecting to a brake anchor plate.

Such disk brake assemblies are well known from the background art. Thus, for example the documents DE 103 12 478 A1, and corresponding U.S. Pat. No. 7,201,258 B2, both of which are incorporated by reference herein in entirety, DE 103 12 479 A1, and corresponding U.S. Pat. No. 7,431,132 B2, both of which are incorporated by reference herein in entirety and DE 103 12 480 A1, and corresponding U.S. Pat. No. 7,377,368 B2, both of which are incorporated by reference herein in entirety, disclose such a disk brake comprising a brake anchor plate, which may be fastened to the vehicle and is provided at the run-in side and at the run-out side of the brake with bolts, which during braking take up the forces acting upon the brake pads. For this purpose the described bolts are configured as stud bolts, which are screwed into a matching internal thread in the brake anchor plate in order to guarantee a fixed connection to the brake anchor plate. It is further described how the stud bolts over part of their longitudinal extent are provided with an external thread, which is used to screw into the corresponding internal thread in the brake anchor plate, and has an additional portion that is configured without a thread. This additional portion is used to mount and support the brake pads.

However, as is common knowledge, with simple screw connections there is in principle always the risk that they may work themselves loose if no extra securing devices are provided. Screw connections of all kinds are intended to clamp together the components connected thereby with a specific force and maintain a sufficiently high clamping force throughout the operating period. The friction in the thread and at the lay-on surfaces of the screw head in this case guarantee self-locking, so that properly tightened screw connections cannot work themselves loose even under conditions of vibratory or shock-like operating forces.

During tightening of the screws their thread flanks and all the interfaces of the components to be connected are pressed hard against one another, so that their surface irregularities flatten out, even additionally to a slight extent after assembly. In the course of time a creeping of the materials that are loaded in the screw connection manifests itself. These processes as a whole lead to a decline of the clamping force that is known as loosening or settling. As soon as an external force, for example in the form of vibratory load forces, that is greater than the existing clamping force acts upon such a connection, the bolts and nuts work themselves loose. In order to counteract this, in such screw connections of prior art extra securing devices are used so that it may be ensured that a loosening of the screw connection as a result of the settling behaviour of the screw is extensively ruled out. Thus, it is known for example to provide the stud bolts of known disk brake assemblies with a special thread, a so-called Power Lock thread, or to use extra locking washers or locking pins that are inserted transversely into the screw connection. Such extra securing measures however also add to the cost of manufacturing such a disk brake assembly. For extra elements as such also have to be additionally manufactured or purchased, stocked and assembled.

A further drawback that has become known in connection with such stud bolts as guide means is that a precisely matching thread has to be cut into the location bore of the brake anchor plate. If the thread is not cut correctly, this leads to more rejects and/or to re-working in order to adapt the thread to the stud bolts that are to be used.

### BRIEF SUMMARY OF THE INVENTION

A feature of the invention is to provide guide elements that may be assembled and manufactured easily and inexpensively.

The feature of the present invention is achieved in that the second portion of a guide element has a textured surface, by which the guide element may be press-fitted at least partially into the location opening.

By virtue of the guide element being, not screwed, but pressed into the location opening there is no longer any need to provide a precisely matching internal thread in the location opening of the brake anchor plate. A considerable cost saving may thereby be achieved because it is possible not only to dispense with the tools and work stages required for this purpose but also to reduce the product reject rate arising from a not precisely matching thread and to increase the cycle times as a result of eliminating a production stage.

Furthermore, the fact that the second portion has a textured surface offers a clear advantage over press fits generally known from the background art, namely that the high specifications that are characteristic of a press fit in terms of the dimensional accuracy and surface quality of the connection partners of such a press fit may be markedly reduced. So, unlike in the background art, it is not necessary to smooth and/or hone the location bore or to grind a smooth surface on the elements that are to be press-fitted therein, which would involve an enormously high manufacturing outlay and lead to high costs. Instead, the textured surface enables within specific limits a resilience and hence the achievement of an increased dimensional tolerance whereby surface irregularities, which may result for example from a casting process for manufacturing the brake anchor plate, may be compensated.

The textured surface of the second portion of the guide element in this case preferably comprises a texture that is visible in the macroscopic range.

In a development of the invention the guide element has a substantially circular cross section orthogonal to the axis. This shape of the guide element offers the advantage that the guide element is easy to manufacture and during the press-fitting operation because of its rotationally symmetrical cross section may be press-fitted in any rotated position about the longitudinal axis of the guide element into the location opening of the brake anchor plate.

In a further development of the invention the textured surface of the second portion may comprise grooves that are disposed transversely of the press-fit direction of the guide element. The press-fit direction in this case denotes the direction, in which the guide element is pressed into the location opening. This direction corresponds substantially in its orientation to the longitudinal axis of the guide element.

In the present case these grooves, which extend transversely of the press-fit direction of the guide element and are disposed on the second portion, are used in particular to secure the guide element in the location opening to prevent it from sliding out. During the press-fit operation the material of the location opening is pressed and/or starts to flow elastically outwards and with progressive press-fit travel springs and/or flows back into the adjacent transverse grooves. In this way an axially effective resistance to the guide element falling out of the location opening is achieved.

The grooves extending transversely to the press-fit direction may be configured as annular grooves or alternatively only as partial grooves that extend over the surface of the guide element over a specific angular portion that is smaller than 360°. In a preferred embodiment of the invention the grooves extend at a right angle to the press-fit direction of the guide element. It may however alternatively be advantageous for the grooves to be disposed at a different angle thereto transversely of the press-fit direction of the guide element. The grooves may further be aligned parallel to one another or extend at different angles transversely of the press-fit direction of the guide element.

It should further be noted that the grooves, viewed in cross section, may have different profiling. Thus, for example it is conceivable for the groove base as well as the transition between the grooves and the outer circumferential surface of the second portion to be of a rounded or angular configuration.

In a preferred embodiment of the invention a plurality of grooves disposed parallel to one another are formed, which extend in an annular manner in peripheral direction on the textured surface of the second portion.

It may further be provided that the textured surface of the second portion comprises grooves that are disposed parallel to the press-fit direction of the guide element. Such grooves have the advantage that, compared to a totally smooth surface, they reduce the friction-generating surface of the second portion of the guide element during the press-fit movement, thereby enabling a facilitated press-fit movement.

During the press-fit operation the parallel extending grooves “dig” or “plough” into the material of the location opening. They therefore act as a guide aid and produce the effect that during the press-fit movement an additional rotatory movement about the longitudinal axis of the guide element does not occur, with the result that all of the press-fit force that is applied to press-fit the guide element may be utilized to press the guide element axially in.

The further possible constructions that have been described in connection with the groove profiling of the transversely extending grooves apply equally to the grooves that are disposed parallel to the press-fit direction of the guide element.

In order in particular to enable an automated assembly of the guide element, it may further be provided that the guide element on a, viewed in press-fit direction, rear (trailing) end has a circumferential collar. As soon as this collar comes into contact with the brake anchor plate, there is a sudden rise in the mounting force that may be detected by an automated system and leads to termination of the assembly step. In this way it is possible to ensure that, even in an automated method of assembling the guide elements, these may be received completely in the location opening of the brake anchor plate. Such a circumferential collar moreover prevents the guide element from shifting in the direction of the brake disk and/or the brake pad assembly during the service life of the disk brake assembly.

In a preferred embodiment it may be provided that the second portion comprises at least one, in the press-fit direction, front region and one rear region, wherein the textured surface of the front region comprises grooves that are disposed parallel to the press-fit direction of the guide element, while the textured surface of the rear region comprises grooves that are disposed transversely of the press-fit direction of the guide element. In this embodiment the individual advantages of both forms of groove construction are combined in one guide element. Thus, the front region is used to facilitate the press-fit operation insofar as the friction-generating surface of the guide element is reduced, thereby enabling a facilitated press-fit movement. The grooves of the front region that extend parallel to the press-fit direction are moreover used to guide the guide element inside the location opening during assembly.

The rear region having the transversely extending grooves, on the other hand, is used to secure the press-fitted guide element in that the material of the brake anchor plate in the region of the location opening as a result of the effective pressure during the press-fit operation flows and/or springs back into the transversely extending grooves and subsequently prevents a loosening movement of the press-fitted guide element. Between the front and the rear region of the second portion further, differently configured surface textures and/or regions having a surface without a macroscopically visible texture may be disposed.

To guarantee improved mountability, it may be provided that the textured surface in a region of the grooves disposed transversely of the entry direction comprises a, viewed in longitudinal section (in relation to the longitudinal axis of the guide element), sawtooth-like profile, wherein the, in press-fit direction, front flanks of the sawtooth profile are configured longer than the rear flanks. The effect achieved by configuring the front flanks of the sawtooth profile longer than the rear flanks is that the transversely disposed grooves ascend in a chamfer-like manner relative to the, in press-fit direction, rear end of the guide element and hence with progressive press-fit travel press the material of the location opening outwards. The outwardly pressed material of the location opening with progressive press-fit movement springs and/or flows back into the transversely extending grooves and hence counteracts a loosening of the guide element. Given such a profiling, the grooves act like barbs, which lock in the event of a movement in the opposite direction to the press-fit direction.

It may equally be provided that the textured surface in a region of the grooves disposed parallel to the press-fit direction comprises a, viewed in the cross section orthogonal to the axis, sawtooth-like profile. The cross section orthogonal to the axis lies in a plane that is disposed at right angles to the longitudinal axis of the guide element. Such a profile has the added advantage that, in dependence upon the selected fit, the contact surface and hence the friction between the guide element and the location opening increases linearly.

A connection of two parts, for example the guide element and the location opening, which engage into one another is described as a fit, wherein both parts have the same nominal size, i.e. the inside diameter of the location opening mutually correspond to the outside diameter (maximum outside diameter in the region of the parallel grooves). However, with regard to their actual dimension the two dimensions of the inside diameter of the location opening and the outside diameter of the guide element may differ by a specific permissible variation. Depending on how great this is selected, the frictional force that hinders the press-fit operation and that simultaneously upon completion of assembly keeps the press-fit element in its location, also varies. With press-fit elements in general an interference fit is provided, i.e. the outside diameter of the press-fit element is substantially greater than the inside diameter of the location opening, so that after assembly a fit is maintained as a result of the existing friction between the parts.

Depending on the design of the profiling of the respective grooves, with an increase of the ratio of outside diameter of the guide element to inside diameter of the location opening the compression rises linearly or non-linearly. A linear rise of the compression is to be expected for example in the case of the sawtooth-like profile of the grooves, while in alternative embodiments, in which the flanks are not linear, a similarly non-linear rise of the compression is to be expected. Thus, the permissible variation of the interference fit may be varied by means of the design of the profile of the grooves (both of the grooves disposed transversely of the press-fit direction and of the grooves disposed along the press-fit direction).

It may further be provided that the front region of the second portion has a smaller diameter than the rear region. In the present case, the diameter denotes the maximum outside diameter of the textured surface. The location opening of the brake anchor plate may moreover be configured as a stepped bore. This corresponds, with regard to the arrangement of its steps, to the graduations of the guide element that result from the different diameters for example of the circumferential collar and the second portion and/or the front and rear region of the second portion.

It may further be provided that the first portion has a substantially smooth surface. This smooth surface is used in a known manner to support the brake pad assembly and therefore requires no special texturing of the surface. Equally, however, a smoothing or honing of the surface is not required.

It may additionally be provided that the first portion of the guide element has a smaller diameter than the second portion. In this case, between the first portion and the second portion a transition chamfer is advantageously disposed, the diameter of which diminishes from the second portion in the direction of the first portion. In particular, this transition chamfer is used during the press-fit operation to press the material of the location opening elastically outwards and with progressive press-fit travel to allow this material to spring and/or flow back into the texturing of the second portion. The transition chamfer is used moreover to centre the guide element during the press-fit operation.

In order to guarantee that the material of the location opening is deformed by the guide element during the press-fit operation, it may further be provided that the guide element is manufactured from a material of a greater hardness than that of the brake anchor plate. If the brake anchor plate is not of an integral construction, it is at least to be ensured that the guide element is manufactured from a material of a greater hardness than that of the location opening in the brake anchor plate. The material of the location opening may therefore comprise for example aluminium.

The present invention further relates to a method of manufacturing a disk brake assembly, wherein the disk brake assembly comprises a brake anchor plate as well as a brake pad assembly, the method being characterized in that, in order to connect the brake anchor plate to a guide element having the previously described features, the step of pressing the guide element into a location opening provided on the brake anchor plate is carried out. In order additionally to secure the guide element in the location opening, the, in press-fit direction, rear portion of the location opening may optionally additionally be caulked so that a projection and/or bead thus produced secures the guide element accommodated in the location opening and prevents it from falling out. Whereas in known methods of manufacturing and assembling disk brake assemblies the guide element in the form of a stud bolt is screwed into a location opening provided in the brake anchor plate, in the present method the press-fitting step is carried out instead. This has the advantage that the location opening need not, as in the background art, be provided with a corresponding internal thread, with the result that the manufacturing costs may be substantially reduced. Thus, on the one hand, the thread-cutting production step as such no longer applies and, on the other hand, the risk of possible reject parts (if the thread has not been properly cut) and possible re-working is also reduced.

By using a guide element having the previously described features, in particular a textured surface, it is guaranteed that alternative method steps, such as are generally known from the press-fit method, for example honing of the parts that are to be connected, are not necessary. The textured surface enables a greater permissible variation with regard to the interference fit that is to be provided between guide element and location opening.

Other advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective part-sectional view of a disk brake assembly according to the invention;

FIG. 2 is a detail view of the detail A in FIG. 1; and

FIG. 3 is a side view of a guide element of the disk brake assembly according to the invention according to FIGS. 1 and 2.

### DETAILED DESCRIPTION OF THE INVENTION

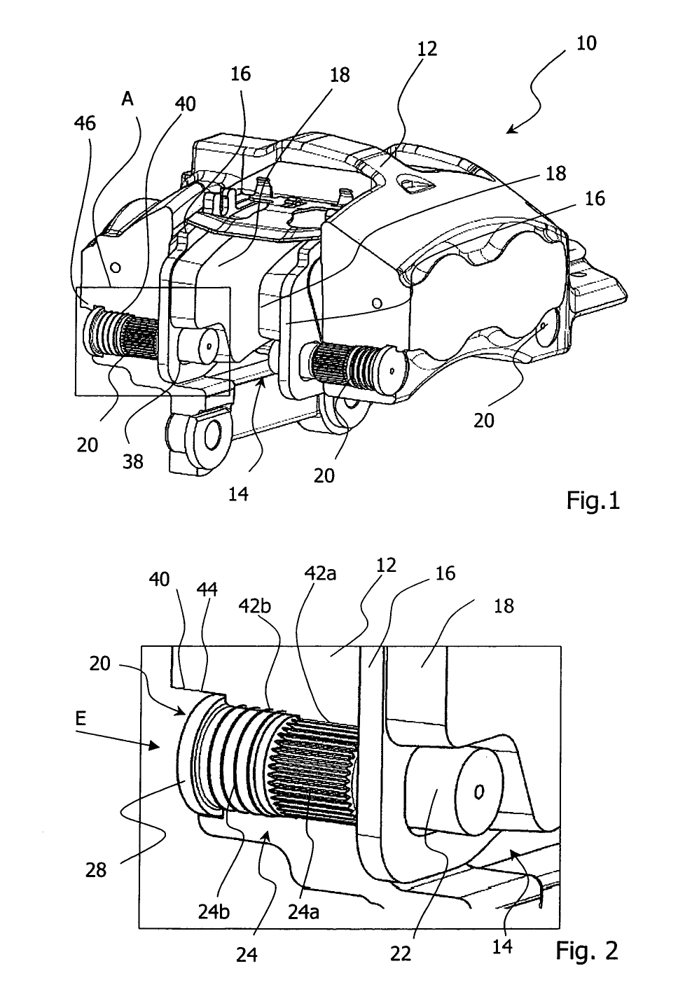

In FIG. 1 a disk brake assembly according to the invention is shown in a part-sectional perspective view and generally denoted by the reference character 10. The disk brake assembly 10 comprises a brake anchor plate 12, which is used to connect the disk brake assembly 10 to a vehicle, as well as a brake pad assembly 14. The brake pad assembly 14 comprises the supporting plates 16 and the brake pads 18 disposed thereon. Guide elements 20 (in FIG. 1, three of four are shown) are accommodated in location openings 40 of the brake anchor plate 12 and are used to guide and support the brake pad assembly 14 of the disk brake assembly 10 according to the invention. For this purpose, each of the guide elements 20 comprises a first portion 22, on which the brake pad assembly 14 is guided and supported for example, as shown in FIG. 1, by means of corresponding location openings 38 in the supporting plates 16.

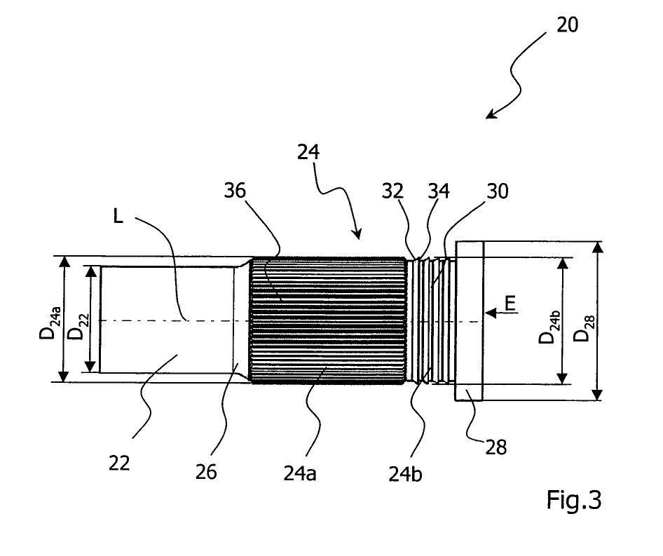

As may be seen clearly in FIG. 2, a detail view of the detail A in FIG. 1, the guide element 20 further comprises a second portion 24, the surface of which is textured. In the case of the guide elements 20 shown in FIGS. 1 to 3 the second portion 24 is divided into two regions, an—in a press-fit direction E—front region 24a and a rear region 24b. The front region 24a of the second portion 24 of the guide element 20 has on its circumference longitudinal grooves 36 (cf. FIG. 3), which are disposed substantially parallel to the press-fit direction E of the guide element 20. The rear region 24b of the second portion 24 of the guide element 20, on the other hand, has on its outer circumferential surface transverse grooves 30, which extend transversely to the press-fit direction E of the guide element 20. In the embodiment represented in FIGS. 1 to 3 the transverse grooves 30 are disposed substantially at right angles to the press-fit direction E.

By virtue of the longitudinal grooves 36 the textured surface of the second portion 24 has in the front region 24a a profiling that, in a cross section orthogonal to the axis (in relation to the longitudinal axis L of the guide element 20), resembles a sawtooth profile, wherein the flanks of the sawtooth profile in the illustrated embodiment are substantially equal in length. Alternative embodiments to this profiling are however equally conceivable, in which for example the flanks are of a concave or convex configuration. Equally, the tooth base and the tooth tips of the profiling may be of a flattened configuration.

The embodiment represented in FIGS. 1 to 3 is advantageous in particular because the longitudinal grooves 36 are used to guide the guide element 20 in the direction of the press-fit direction E and hence facilitate pressing of the guide element 20 into the location opening 40. Furthermore, the compression increases or decreases linearly (directly proportionally) as a function of the ratio of the maximum outside diameter D₂₄ₐ of the front region 24a to the inside diameter of the location bore 40.

As is shown in FIG. 3, on the textured surface of the rear region 24b of the second portion 24 of the guide element 20 a profiling is likewise formed by means of the transverse grooves 30 on the guide element 20. This profile, viewed in the direction of the longitudinal axis L of the guide element 20, likewise resembles a sawtooth-like profile, in which the, in press-fit direction E, front flanks 32 are configured longer than the rear flanks 34.

By virtue of such a configuration of the sawtooth-like profile of the textured surface of the rear region 24b of the second portion 24 of the guide element 20, a facilitated movement of the guide element 20 in press-fit direction E into the location bore 40 is achieved, while a movement in the opposite direction is prevented or at least hampered by the barb-like locking of the transverse grooves 30. Thus, the transverse grooves 30 are used in particular to secure the guide element 20 in the location opening 40 of the brake anchor plate 12.

As may be seen in FIG. 3, the first portion 22 has a smaller diameter D₂₂ than the second portion 24. There is therefore provided between the first portion 22 and the second portion 24 of the guide element 20 a transition chamfer 26, by means of which on the one hand the second portion 24 that is to be press-fitted may be centred as it is introduced into the location opening 40. On the other hand the transition chamfer 26 is used already to deform the material of the location opening 40 elastically outwards in order to facilitate the press-fit operation.

On the, in press-fit direction E, rear end of the guide element 20 a circumferential collar 28 is further provided, the diameter D₂₈ of which is greater than the diameters D₂₄ₐ and D_{24b} of the front region 24a and the rear region 24b of the second portion 24. The circumferential collar 28 is used to terminate and/or discontinue the press-fit operation as soon as the collar 28 of the guide element 20 comes into contact with the brake anchor plate 12. Particularly in the case of automated assembly, when the collar 28 is resting against the brake anchor plate 12 a sudden rise in the assembly force may be detected by suitable sensor equipment and as a consequence thereof the press-fit operation is terminated.

There now follows a description with reference to FIGS. 2 and 3 of the manufacture and the assembly of a guide element 20 in a disk brake assembly according to the invention. In a first manufacturing step the guide element 20 is configured as a blank in the form of a bolt with a circular cross-sectional area, which in a further manufacturing step is formed into a stepped bore. In the present case, a first step is formed by making the diameter D₂₂ of the first portion 22 smaller than the diameter of the second portion 24 and/or the diameter D₂₄ₐ of the front region 24a of the second portion 24. A further step is formed in the present embodiment of the guide element 20 by making the diameter D₂₄ₐ of the front region 24a of the second portion 24 slightly smaller than the diameter D_{24b} of the rear region 24b of the second portion 24. A final step is formed by the circumferential collar 28, the diameter D₂₈ of which is greater than the diameter of the second portion 24 and/or the diameter D_{24b} of the rear region 24b of the second portion 24.

In a third manufacturing step approximately half of the second portion 24 of the guide element 20, which in the assembled state is situated in the compression region, is drawn through a female die, which shapes the previously substantially smooth lateral surface into a textured, preferably tooth-shaped lateral surface. In this case, the maximum outside diameter D₂₄ₐ of the front region 24a, which is shaped in this manner, is substantially unaltered, i.e. only indentations in the form of longitudinal grooves 36 are formed. The effect achieved by these longitudinal grooves 36 in the front region 24a of the second portion 24 of the guide element 20 is that this region of the portion 24, when it is subsequently pressed axially in press-fit direction E into the location opening 40 of the brake anchor plate 12, may plough into the brake anchor plate 12. Compared to the conventional interference fit this ploughing-in offers the crucial advantage that the component tolerances, i.e. the ratio of the outside diameter of the second portion 24 to the inside diameter of the location opening 40, may turn out significantly larger than in the case of interference fit partners having a substantially smooth surface. As a result, the manufacturing process is much less expensive.

In a further manufacturing step, between the first portion 22 and the front region 24a of the second portion 24 of the guide element 20 a transition chamfer 26 is provided, which ensures that the compression portion 24 of the guide element 20 during the press-fit operation automatically centres itself in relation to the location opening 40 in the brake anchor plate 12.

The rear region of the second portion 24 is moreover provided with indentations extending transversely to the longitudinal axis L and/or with transverse grooves 30, the outside diameter D_{24b} of which corresponds substantially to the diameter of the rear region 24b of the stepped blank. The transverse grooves 30 in this case are configured in such a way that the, in press-fit direction E, front flanks 32 of the profiling visible in the longitudinal section of the guide element 20 are longer than the rear flanks 34, so that the profiling is configured like a chamfer increasing in diameter in the direction of the collar 28.

During press-fitting of the guide element 20, first the portion 22 of reduced diameter D₂₂ is introduced into the location opening 40. Preferably between the outside diameter D₂₂ and the inside diameter of the location opening 40 there is enough play to allow the introduction movement to occur unimpeded. With progressive introduction travel the transition chamfer 26 moves into the location opening 40 and presses the material of the opening 40 elastically outwards. At the same time a centring of the guide element 20 is achieved by means of the transition chamfer 26.

By applying an axial assembly force the front region 24a of the second portion 24 having the longitudinal grooves 36 as well as the adjoining rear region 24b of the second portion 24 having the transverse grooves 30 are then press-fitted into the location opening 40. At the same time, the longitudinal grooves 36 plough into the location opening and hence enter into a friction—and positive locking therewith. During press-fitting of the rear region 24b, by virtue of the chamfer-like profiling of the transverse grooves 30 the material of the bore is only then pressed elastically outwards and/or begins to flow as a result of the pressure and with progressive press-fitting springs and/or flows back into the succeeding transverse groove 30, with the result that an axially effective resistance to falling-out of the guide element 20 is realized.

Generally, by providing the transverse grooves 30 and the longitudinal grooves 36 the permissible variation, i.e. the permissible ratio between the outside diameter of the second portion 24 and the inside diameter of the location opening 40, is moreover extended and the manufacturing costs are reduced compared to the background art.

The circumferential collar 28 adjoining the rear region 34b limits the maximum possible press-fit depth of the guide element 20 into the brake anchor plate 12 and enables an automated assembly, during which a discontinuation of assembly is prompted by a sudden rise of the assembly force that is caused by the collar 28 coming into contact with the brake anchor plate 12.

As may further be seen in FIG. 2, depending on the development of the guide element 20 a corresponding stepped configuration of the location opening 40 in the brake anchor plate 12 is also advantageous. So, in the embodiment represented in FIG. 2 the location opening 40 is provided with two stepped portions 42a, 42b, which correspond in each case to the front region 24a and the rear region 24b of the second portion 24 of the guide element 20, and with a third stepped portion 44, which corresponds substantially to the outside diameter D₂₈ of the circumferential collar 28. However, depending on the development of the guide element 20 and the material of the location opening 40 it may also be possible to leave the location opening 40 free of steps.

Finally, as shown in FIG. 1, the guide element 20 may be secured in the location opening 40 to prevent it from falling out in an opposite direction to the press-fit direction E in that the location opening 40 is finally caulked at the third stepped portion 44, i.e. the edge region of the third stepped portion 44 is plastically deformed in such a way as to form a projection and/or bead 46 that secures the guide element 20 in axial direction.

The material of the location opening 40 in this case is designed to be softer than that of the guide element 20; for example the location opening 40 and/or the brake anchor plate 12 of the represented embodiment of FIGS. 1 to 3 is manufactured from aluminium. As soon as the guide elements 20 are fitted on the brake anchor plate 12, the brake pad assembly 14 is provided on the disk brake assembly 10 according to the invention.

Unlike conventional disk brake assemblies, in the disk brake assembly 10 according to the invention the guide element 20 is press-fitted into a location opening 40 disposed in the brake anchor plate 12. This makes the provision of a thread on the location opening 40 equally as unnecessary as the extra provision of a device for securing this screw connection. The method according to the invention of manufacturing a disk brake assembly moreover offers the advantage that, in order to connect the brake anchor plate 12 to a guide element 20, only the step of press-fitting the guide element 20 in a location opening 40 provided in the brake anchor plate 12 is carried out. Extra machining steps to prepare the location opening 40, such as for example smoothing or honing the inner circumferential surface, are unnecessary owing to the textured surface of the compression portion 24 of the guide element 20.

The present invention therefore offers the advantages of inexpensive and easy manufacture of a disk brake assembly.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Disk brake assembly comprising a brake anchor plate for fastening to a vehicle as well as a brake pad assembly, wherein the brake anchor plate has at least one location opening for receiving a guide element that has a first portion for guiding and supporting the brake pad assembly and a second portion for connecting to the brake anchor plate,
wherein the second portion has a textured surface, by which the guide element may be press-fitted at least partially into the location opening.

2. Disk brake assembly according to claim 1,
wherein the guide element has a substantially circular cross section orthogonal to a longitudinal axis thereof.

3. Disk brake assembly according to claim 1,
wherein the textured surface of the second portion comprises grooves that are disposed transversely of a press-fit direction of the guide element.

4. Disk brake assembly according to claim 1,
wherein the textured surface of the second portion comprises grooves that are disposed parallel to a press-fit direction of the guide element.

5. Disk brake assembly according to claim 1,
wherein the guide element on a, viewed in a press-fit direction, rear end has a circumferential collar.

6. Disk brake assembly according to claim 1,
characterized in that wherein the second portion comprises at least one, in a press-fit direction, front region and one rear region, wherein the textured surface of the front region comprises grooves that are disposed parallel to the press-fit direction of the guide element, while the textured surface of the rear region comprises grooves that are disposed transversely of the press-fit direction of the guide element.

7. Disk brake assembly according to claim 3,
wherein the textured surface in a region of the grooves disposed transversely of the press-fit direction has a profile that, viewed in the cross section orthogonal to the axis, is sawtooth-like.

8. Disk brake assembly according to claim 4,
wherein the textured surface in a region of the grooves disposed parallel to the press-fit direction has a profile that, viewed in the longitudinal section, is sawtooth-like, wherein, in the press-fit direction, front flanks of the sawtooth-like profile are configured longer than the rear flanks.

9. Disk brake assembly according to claim 6,
wherein the front region of the second portion has a smaller diameter than the rear region.

10. Disk brake assembly according to claim 1,
wherein the location opening of the brake anchor plate is configured as a stepped bore.

11. Disk brake assembly according to claim 1,
wherein the first portion has a substantially smooth surface.

12. Disk brake assembly according to claim 1,
wherein the first portion of the guide element has a smaller diameter than the second portion.

13. Disk brake assembly according to claim 12,
wherein disposed between the first portion and the second portion is a transition chamfer, the diameter of which diminishes from the second portion in the direction of the first portion.

14. Disk brake assembly according to claim 1,
wherein the guide element is manufactured from a material of a greater hardness than that of the brake anchor plate.

15. Method of manufacturing a disk brake assembly, wherein the disk brake assembly comprises a brake anchor plate as well as a brake pad assembly,
wherein, in order to connect the brake anchor plate to a guide element according to claim 1, the step of press-fitting the guide element into a location hole provided in the brake anchor plate is carried out.
